(19) United States
(12) Patent Application Publication
(10) Pub. No.: US 2007/0186102 A1
(43) Pub. Date: Aug. 9, 2007

(54) Method and apparatus for facilitating fine-grain permission management

(76) Inventor: Raymond K. Ng, San Jose, CA (US)

Correspondence Address: ORACLE INTERNATIONAL CORPORATION;c/o PARK, VAUGHAN & FLEMING LLP, 2820 FIFTH STREET, DAVIS, CA, 95618-7759, US

(21) Appl. No.: 11/728,800

(22) Filed: Mar. 26, 2007

Related U.S. Application Data
(63) Continuation-in-part of application No. 10/430,737, filed on May 6, 2003.

(51) Int. Cl. H04N 7/16; H04L 9/00; H04L 9/32; G06F 17/30; G06F 7/04; G06K 9/00; H03M 1/68; H04K 1/00

(52) U.S. Cl. 713/165; 713/167; 726/26

(57) ABSTRACT

One embodiment of the present invention provides a system that facilitates fine-grain permission management and delegated policy administration. During operation, the system creates a permission associated with a resource. The system also creates an admin permission associated with the permission. Next, the system associates the admin permission with a user. Finally, the system performs an administrative action on the permission, wherein the administrative action is enabled by the admin permission.

### RELATED APPLICATION

This application is a continuation-in-part of, and hereby claims priority under 35 U.S.C. §120 to, U.S. patent application Ser. No. 10/430,737, entitled “SYSTEM AND METHOD FOR PERMISSION ADMINISTRATION USING META-PERMISSIONS,” by inventor Raymond K. Ng, filed on 6 May 2003 (Attorney Docket No. OR02-18701), and is herein incorporated by reference.

### BACKGROUND

1. Field of the Invention

The present invention relates to computer security. More specifically, the present invention relates to a method and apparatus for facilitating fine-grain permission management.

2. Related Art

As permission-based (or capability-based) authorization systems become more popular, it is becoming increasingly more important to be able to manage permissions securely. Currently, organizations typically rely on a security administrator to manage security policies across an enterprise system. In doing so, the organization has to trust the administrator's ability to understand enterprise-wide security requirements or rules covering a wide range of resources, and to accurately capture these requirements in the form of an enforceable security policy (or policies). If the enterprise system is large or complex, the organization has to rely on multiple administrators to manage permissions. However, using multiple administrators increases the probability of giving administrative control to a malicious administrator.

Furthermore, many enterprise systems use “permission classes” to provide security, such as those available with the Java Authentication and Authorization Service (JAAS). Unlike traditional permissions, such as bit-string permissions associated with access control lists (ACLs), these permission classes are dynamic and extensible. This means that an organization can define new permission classes to protect custom resources, or to customize a system-predefined permission to capture domain-specific security requirements. By introducing this flexibility into a permission based security system, the administrator's task becomes more complex. This complexity increases as the number of permission classes increases because there is no uniform syntax or language that constrains these permission classes. In other words, each permission-class designer can define a unique permission-specific language to capture the protection policies implemented by the permission class. Furthermore, the varying semantics of each permission class increases the probability of an administrator making a mistake when administering the enterprise system.

Hence, what is needed is a system that facilitates fine-grain permission management without the problems listed above.

### SUMMARY

One embodiment of the present invention provides a system that facilitates fine-grain permission management and delegated policy administration. During operation, the system creates a permission associated with a resource. The system also creates an admin permission associated with the permission. Next, the system associates the admin permission with a user. Finally, the system performs an administrative action on the permission, wherein the administrative action is enabled by the admin permission.

In a variation on this embodiment, the permission can comprise a class, wherein the class can include: a second permission associated with the resource; multiple permissions associated with the resource; an authentication-test for the user; and a policy specification for the resource.

In a variation on this embodiment, the admin permission can comprise a class that specifies administrative actions on the permission that the system can grant to the user.

In a further variation, the permission can be a second admin permission.

In a variation on this embodiment, the administrative action can include: a modify action; a delete action; a grant action; and a revoke action.

In a variation on this embodiment, while performing the administrative action, the system receives the admin permission and the permission. Next, the system determines if the user is associated with the admin permission. If so, the system determines if the admin permission allows the user to perform the administrative action on the permission. If so, the system performs the administrative action on the permission.

In a further variation, receiving the permission involves receiving a target indicator, which specifies the resource that the permission is associated with.

In a further variation, determining if the admin permission allows the user to perform the administrative action on the permission involves determining if the user is authorized to perform the administrative action on the permission for the resource.

In a variation on this embodiment, associating the admin permission with the user creates an association between a second admin permission and the user.

In a variation on this embodiment, the admin permission's association with the permission creates an association between the admin permission and a third permission.

In a variation on this embodiment, associating the admin permission with the user creates an association between the permission and the user.

In a variation on this embodiment, the permission and the admin permission are stored on a database.

### BRIEF DESCRIPTION OF THE FIGURES

FIG. 1 illustrates a computing environment in accordance with an embodiment of the present invention.

FIG. 2 illustrates a permission hierarchy in accordance with an embodiment of the present invention.

FIG. 3 presents a flowchart illustrating the process of creating an admin permission in accordance with an embodiment of the present invention.

FIG. 4 presents a flowchart illustrating the process of performing an administrative action on a permission in accordance with an embodiment of the present invention.

Table I illustrates examples of using an admin permission in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

Overview

One embodiment of the present invention provides a fine-grain permission management system that does not depend on external security models, such as access control lists (ACL), to secure an enterprise system. This fine-grain permission management system provides an administrative permission class, or admin permission, which helps regulate who can administer an enterprise system by functioning as a meta-permission class (or a permission class for other permission classes). Typically, an administrator controls who has access to a resource. By using an admin permission, the administrator can grant a user administrative control or partial administrative control over the permission that protects the resource. Thus, the user becomes a second administrator of the resource protection policy and can control who can access the resource. This can alleviate some of the burden on the administrator. Note that the fine-grain permission management system works in a transparent manner and therefore, the fine-grain permission management system can work with both existing permissions and new permissions.

In one embodiment of the present invention, by using an admin permission, the fine-grain permission management system can secure administrative operations over any known, unknown, defined, or as of yet undefined permission class which defines its own syntax or permission-specific language without the fine-grain permission management system having a priori knowledge of the syntax or the permission-specific language. For example, suppose that access to an organization's financial files are governed by a permission class that specifies ‘*’ as a wildcard for selecting all files. Furthermore, suppose that access to the organization's employee information files are governed by a permission class that specifies ‘%’ as a wildcard for selecting all files. In this example, the administrator can grant the user administrative control over the permission classes or the files associated with the permission classes. In this example, the fine-grain permission management system ensures that the administrator has previously been granted the appropriate admin permission over the permission classes before enabling the administrator to grant the user administrative control over the permission classes. Note that the fine-grain permission management system does not require knowledge about how the permission classes are defined or how they function to secure this management action.

In one embodiment of the present invention, the administrator can grant fine-grain administrative control to the user. For example, the administrator can grant the user the ability to grant and revoke read access to a resource, or the administrator can grant the user the ability to grant any type of access to the resource, but not to revoke access to the resource.

In one embodiment of the present invention, the admin permission is a generic permission class that accepts an instantiation of any permission class, including a second admin permission class, as a target. This enables a developer to create a permission class without concern for how the administrator will administer an instantiation of the permission class—in other words, the fine-grain permission management system does not require knowledge of the definition and design of the permission class.

In one embodiment of the present invention, an administrator, A1, can use the fine-grain permission management system to grant a user, U1, a permission, P1. For example, A1 can call a grant method included in an application programmer interface (API) associated with the fine-grain permission management system to grant P1 to U1 (i.e. grant(U1, P1)). In this embodiment, before U1 is granted P1, the fine-grain permission management system determines if A1 has an admin permission (AP) that enables A1 to grant P1 to U1. For example, to determine this, the fine-grain permission management system can use a checkPermission method (i.e. checkPermission(AP(P1, grant))) to determine if A1 has the admin permission required to grant P1 to U1. If so, the fine-grain permission management system grants P1 to U1. Note that U1 has P1 and can access any resource P1 provides access to, however, U1 cannot perform any administrative actions over P1. Note that the fine-grain permission management system does not require a priori knowledge of P1 or how P1 functions.

In one embodiment of the present invention, the administrator, A1, can use the fine-grain permission management system to grant a user, U2, administrative control over the permission, P1. For example, A1 can call a grant method included in an application programmer interface (API) associated with the fine-grain permission management system to grant U2 administrative control over P1, such as granting and revoking P1, to other users (i.e. grant(U2,(AP(P1, grant && revoke)))). In this embodiment, before U2 is granted the admin permission over P1, the fine-grain permission management system determines if A1 has an admin permission that enables A1 to grant U2 a grant and revoke admin permission over P1. For example, to determine this, the fine-grain permission management system can use a checkPermission method (i.e. checkPermission(AP(AP(P1, grant && revoke), grant))) to determine if A1 has the admin permission required to grant U2 the grant and revoke admin permission over P1. If A1 does have this admin permission, the fine-grain permission management system grants U2 the ability to grant and revoke P1 to other users. Note that although U2 can grant and revoke P1, U2 may or may not have P1. However, U2 can grant P1 to U2. Furthermore, note that U2 does not have the ability to grant administrative control over P1 to other users. Moreover, note that the fine-grain permission management system does not require a priori knowledge of P1 or how P1 functions.

In one embodiment of the present invention, U2 can only grant and/or revoke P1 to a set of users identified by A1 when A1 grants U2 administrative control over P1.

In one embodiment of the present invention, the administrator, A1, can use the fine-grain permission management system to grant a user, U3, delegated administrative control—including the ability to grant and/or revoke administrative control—over permission P1.-. For example, A1 can call a grant method included in an application programmer interface (API) associated with the fine-grain permission management system to grant U3 administrative control over an admin permission that provides the ability to grant and/or revoke access to P1, such as granting and revoking the admin permission, to other users (i.e. grant(U3, AP(AP(P1, grant && revoke), grant && revoke))). In this embodiment, before U3 is granted the admin permission over the admin permission that enables a user to grant and revoke P1, the fine-grain permission management system determines if A1 has an admin permission that enables A1 to grant U3 a grant and revoke admin permission over an admin permission that enables a user to grant and revoke P1. For example, to determine this, the fine-grain permission management system can use a checkPermission method (i.e. checkPermission(AP(AP(AP(P1, grant && revoke), grant && revoke), grant))) to determine if A1 has the admin permission required to grant U3 an admin permission that enables U3 to grant and revoke an admin permission over P1 to other users. If A1 does have this admin permission, the fine-grain permission management system grants U3 the ability to grant and revoke an admin permission over P1 to other users. Note that although U3 can grant and revoke an admin permission over P1, this grant by itself does not grant U3 the admin permission over P1. However, U3 can grant the admin permission over P1 to U3. Furthermore, note that U3 does not have the ability to grant administrative control over the admin permission over P1 to other users.

Moreover, note that the fine-grain permission management system does not require a priori knowledge of P1 or how P1 functions.

In one embodiment of the present invention, U3 can only grant and/or revoke the admin permission over P1 to a set of users identified by A1 when A1 grants U3 administrative control over the admin permission over P1.

Table I summarizes the aforementioned examples of using an admin permission:

TABLE I
Examples of Using an Admin Permission

| | | Pre-condition: the fine-grain | |
|---|---|---|---|
| | | permission management | |
| | | system determines if A1 is | |
| | | authorized to perform this | |
| | A1 calls a grant | operation by calling a | |
| | method, | checkPermission method, | |
| | grant(u, p), with | checkPermission(p), with the | |
| Examples: | the parameters: | parameter: | Post-condition: |
| A1 grants P1 to U1 | u = U1, p = P1 | p = AP(P1, grant) | U1 is granted P1 |
| A1 grants AP(P1, | u = U2, p = AP | p = AP(AP(P1, grant && | U2 is granted |
| grant && revoke) to | (P1, grant) | revoke), grant) | AP(P1, grant && |
| U2 | | | revoke) |
| A1 grants | u = U3, p = AP | p = AP(AP(AP(P1, grant && | U3 is granted |
| AP(AP(P1, grant | (AP(P1, | revoke), grant && revoke), | AP(AP(P1, grant |
| && revoke), grant | grant), grant) | grant) | && revoke), grant |
| && revoke) to U3 | | | && revoke) |

In one embodiment of the present invention, the admin permission class is a file that the fine-grain permission management system executes. In this embodiment, the operating system or environment executing the enterprise system does not need to be aware of the admin permission. For example, the fine-grain permission management system can execute within a virtual machine, which can prevent the operating system or environment from being aware of the admin permission.

In one embodiment of the present invention, an initial administrator is granted a master permission which grants the initial administrator all other permissions. This master permission can be granted to the initial administrator during installation of the fine-grain permission management system.

In one embodiment of the present invention, the master permission grants the initial administrator full administrative control over all other permissions.

In one embodiment of the present invention, the master permission grants the initial administrator partial administrative control over all other permissions. In this embodiment, the initial administrator may only grant and/or revoke the other permissions.

In one embodiment of the present invention, the fine-grain permission management system maintains a registry that includes all the permission classes. As permissions are registered/deregistered from the registry, the fine-grain permission management system can automatically grant/revoke administrative control to the initial administrator.

Computing Environment

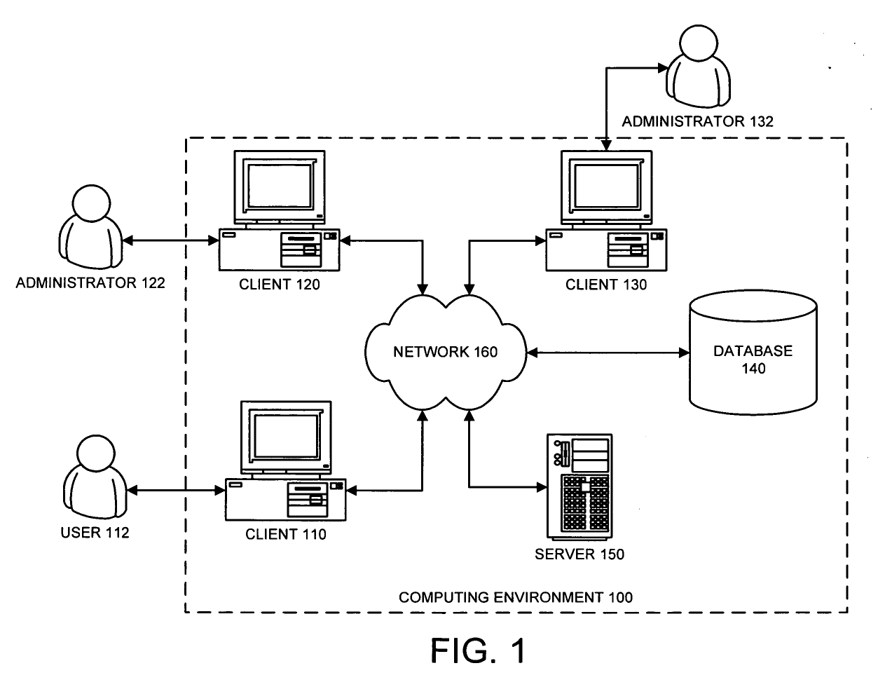

FIG. 1 illustrates a computing environment 100 in accordance with an embodiment of the present invention. Computing environment 100 includes a number of computer systems. These computer systems can generally include any type of computer system based on a microprocessor, a mainframe computer, a digital signal processor, a portable computing device, a personal organizer, a device controller, or a computational engine within an appliance. More specifically, computing environment 100 includes client 110, client 120, client 130, database 140, server 150, and network 160.

Clients 110, 120, and 130 can generally include any node on a network including computational capability and including a mechanism for communicating across the network.

Database 140 can generally include any type of system for storing data in non-volatile storage. This includes, but is not limited to, systems based upon magnetic, optical, and magneto-optical storage devices, as well as storage devices based on flash memory and/or battery-backed up memory. In one embodiment of the present invention, database 140 can include a permission management system, which can store permissions, admin permissions, and security policy related information.

In one embodiment of the present invention, a permission can comprise a class, such as a Java class, which can specify user 112's level of access to a resource. This class can include: a second permission associated with the resource; multiple permissions associated with the resource; an authentication-test for the user; a policy specification for the resource; and any other information or capability that can facilitate regulating user 112's level of access to the resource. Note that this permission is not equivalent to a simple binary permission scheme, such as an access control list (ACL) or role based access control (RBAC), but can be a complex instantiation of a security policy, which can include the use of or definition of an ACL, an RBAC, or any other simple or complex permission scheme.

In one embodiment of the present invention, a resource can include: a file; a table; a datum; an application; or any resource that a permission can regulate user 112's access to.

In one embodiment of the present invention, an admin permission can comprise a class that specifies administrative actions that administrator 132 can perform on a permission. In this embodiment, the admin permission is a meta-permission, or a permission wherein the resource is a second permission.

In one embodiment of the present invention, an administrative action can include: a modify action; a delete action; a grant action; a revoke action; and any other action that administrator 132 can perform in relation to a permission.

Server 150 can generally include any computational node including a mechanism for servicing requests from a client for computational and/or data storage resources. In one embodiment of the present invention, server 150 can include a system that facilitates fine-grain permission management.

Network 160 can generally include any type of wired or wireless communication channel capable of coupling together computing nodes. This includes, but is not limited to, a local area network, a wide area network, or a combination of networks. In one embodiment of the present invention, network 160 comprises the Internet.

In one embodiment of the present invention, server 150 includes several resources whose access server 150 regulates via permissions. Suppose that administrator 132 controls who has access to the resources by granting and revoking the permissions to users, such as user 112. Furthermore, suppose that administrator 132 is too busy to regulate all accesses to each resource on server 150. By using an admin permission, administrator 132 can grant administrator 122 the ability to perform administrative actions on a subset of the permissions. This enables administrator 132 to delegate a subset of the access control responsibilities for a given set of resources. For example, administrator 132 can use an admin permission associated with all admin permissions to grant administrator 122 control over file-read permissions by granting administrator 122 an admin permission associated with the file-read permissions. Then, administrator 122 can use the admin permission associated with the file-read permissions to grant user 112 file-read access to a file-resource. Note that administrator 122 cannot grant user 112 file-write access, or any other permission, to the file-resource because administrator 132 did not grant administrator 122 an admin permission associated with file-write access.

In one embodiment of the present invention, after administrator 132 grants administrator 122 the admin permission, or a set of admin permissions, administrator 122 can in turn grant to a third administrator the set of admin permissions or a subset of the admin permissions. (Note that this assumes that administrator 132 granted administrator 122 the ability to grant the set of admin permissions, or the subset of the admin permissions, to the third administrator.)

In one embodiment of the present invention, before executing a requested administrative action on a permission, server 150 executes a “check permission method” that determines if administrator 122 has permission to execute the administrative action. Note that this check permission method moves the responsibility of authorizing and/or authenticating administrator 122 from the permission to the admin permission thereby enabling the fine-grain permission management system to function with any given permission without modifying a permission class file associated with the permission.

In one embodiment of the present invention, executing the check permission method involves executing an “imply method” which determines if any admin permissions administrator 122 already possesses imply any additional permissions required to execute the requested administrative action on the permission.

In one embodiment of the present invention, executing the check permission method involves determining if administrator 122 has permission to execute the administrative action on a given target permission or resource.

Permission Hierarchy

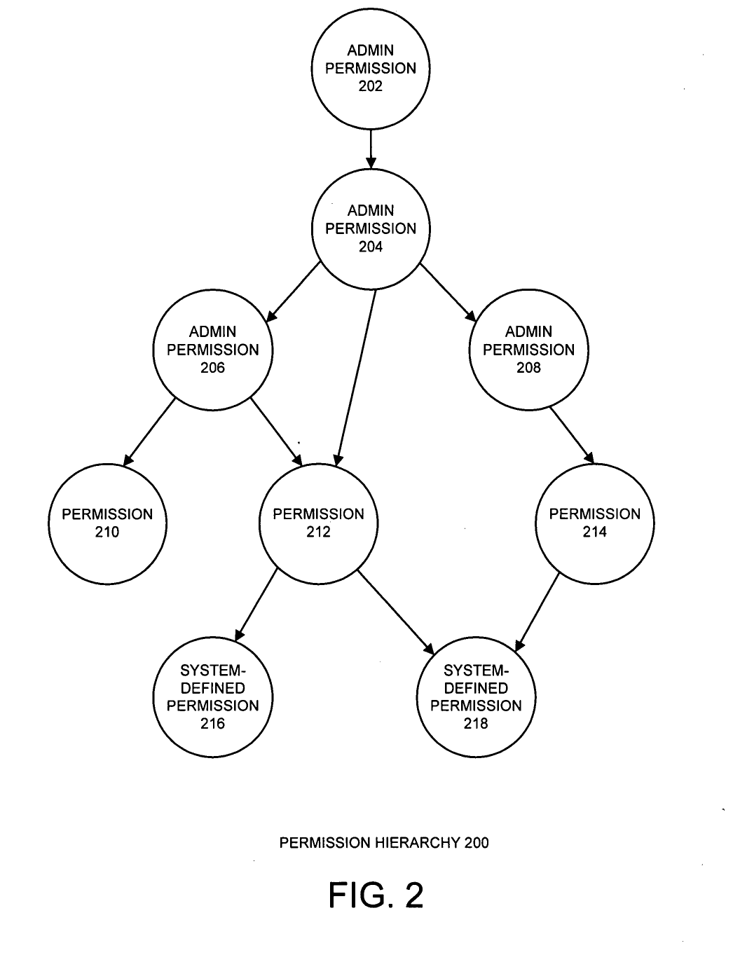

FIG. 2 illustrates a permission hierarchy 200 in accordance with an embodiment of the present invention. Permission hierarchy 200 includes several exemplary permission types including: admin permissions, permissions, and system-defined permissions.

System-defined permissions, can generally include any simple or low-level permissions, such as those associated with the language runtime (virtual machine), or an operating environment. These system-defined permissions generally are binary in nature: a user or system either has authorization or does not have authorization to access a resource. However, system-defined permissions can also include more complex permissions, such as permission-classes which help regulate access to the language runtime, or the operating environment.

Permissions can generally include any complex permissions that a user, such as a system developer, creates to regulate access to resources. These permissions can implement ACL, RBAC, or any custom security policy. Note that these permissions can include: user-defined permissions; system-defined permission objects (in contrast to the traditional binary-based system-defined permissions); pre-defined permissions; and any other type of complex permission that is not binary in nature. An example of an applications programming interface (API) that allows for the creation of permissions is the Java Authentication and Authorization Service (JAAS) API.

Admin permissions can generally include any permissions that regulate who can perform administrative actions on a target permission. This target permission can include: a permission, a second admin permission, or a system-defined permission.

In one embodiment of the present invention, permissions and admin permissions are implemented as instantiations of class files. These class files can specify: security policies; data associated with the permissions and admin permissions; methods that facilitate the granting or revoking of the permissions and admin permissions; and any other data and/or method that can facilitate performing actions on a resource, or administrative actions on the permission or the admin permission. Note that the permissions and admin permissions are active pieces of a security system and are capable of performing actions. This is in contrast to system-defined or traditional permissions, which are passive and are not capable of performing actions.

In one embodiment of the present invention, for a user or administrator to have a given permission (admin permission, permission, or system-defined permission) within permission hierarchy 200, server 150 requires that the user have all the descendent permissions, as illustrated by the unidirectional arrows in FIG. 2. For example, user 112 having permission 212 implies that user 112 has system-defined permissions 216 and 218. If user 112 does not have system-defined permission 216 or 218, then administrator 132 cannot grant user 112 permission 212 even if administrator 132 has admin permission 204.

In one embodiment of the present invention, admin permission 202 serves as a master permission, or a grant all permission. The administrator who installs the fine-grain permission management system assigns this permission at install time, typically to the administrator installing the system. Associating admin permission 202 with an administrator, such as administrator 132, implies that administrator 132 is associated with all descendent permissions (admin permissions, permissions, and system-defined permissions). Thus, administrator 132 can grant admin permissions 204, 206, and 208, permissions 210, 212, and 214, and system-defined permissions 216, and 218 to administrator 122 or to user 112.

In one embodiment of the present invention, having the master permission implies that administrator 132 has access to all permissions.

In one embodiment of the present invention, having the master permission implies that administrator 132 has grant/revoke access to all permissions. In this embodiment, administrator 132 may or may not have additional access beyond grant/revoke access to all permissions.

In one embodiment of the present invention, admin permissions can be chained together. Therefore, if administrator 122 has admin permission 204, then administrator 122 has admin permissions 206 and 208 regardless of whether administrator 132 explicitly granted administrator 122 admin permissions 206 and 208. These chained or composite admin permissions enable administrator 132 to grant multiple admin permissions by granting a single admin permission, such as admin permission 204.

In one embodiment of the present invention, admin permissions and permissions can be chained together. Therefore, if administrator 122 has admin permission 204, then administrator 122 has admin permission 206, admin permission 208, and permission 212 regardless of whether administrator 132 explicitly granted administrator 122 admin permission 206, admin permission 208, and permission 212. These chained or composite admin permissions enable administrator 132 to grant multiple admin permissions and permissions by granting a single admin permission or permission, such as admin permission 204.

In one embodiment of the present invention, admin permissions can be self-referential. For example, if admin permission 208 grants its owner delete access to a target and administrator 132 wants to grant administrator 122 delete access to admin permission 208, administrator 132 can grant administrator 122 admin permission 208 with a target of admin permission 208.

In one embodiment of the present invention, an operating system associated with server 150 grants system-defined permissions 216 and 218. In this embodiment, system-defined permission 216 and 218 are not part of permission hierarchy 200.

In one embodiment of the present invention, a user, such as administrator 122, having a permission, does not imply that the user has any descendent permissions. Thus, administrator 122 having admin permission 206 does not imply that administrator 122 has permissions 210 and 212.

Creating an Admin Permission

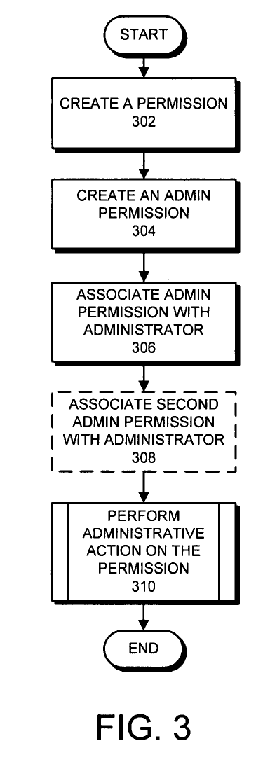

FIG. 3 presents a flowchart illustrating the process of creating an admin permission in accordance with an embodiment of the present invention. The process begins when server 150 creates a permission associated with a resource (step 302). Server 150 also creates an admin permission, which server 150 then associates with the permission (step 304). In one embodiment of the present invention, creating the permission and the admin permission involves creating an instantiation of a permission class and an instantiation of an admin permission class. Next, server 150 associates the admin permission with an administrator, such as administrator 132 (step 306).

In one embodiment of the present invention, associating the admin permission with administrator 132 also associates a second admin permission, a permission, or a system-defined permission with administrator 132 (step 308). (This step is optional as is illustrated by the dashed lines surrounding step 308.)

In one embodiment of the present invention, associating the admin permission with the permission also associates the admin permission with a second admin permission, a second permission, or a system-defined permission.

In one embodiment of the present invention, server 150 stores the permission and the admin permission on database 140.

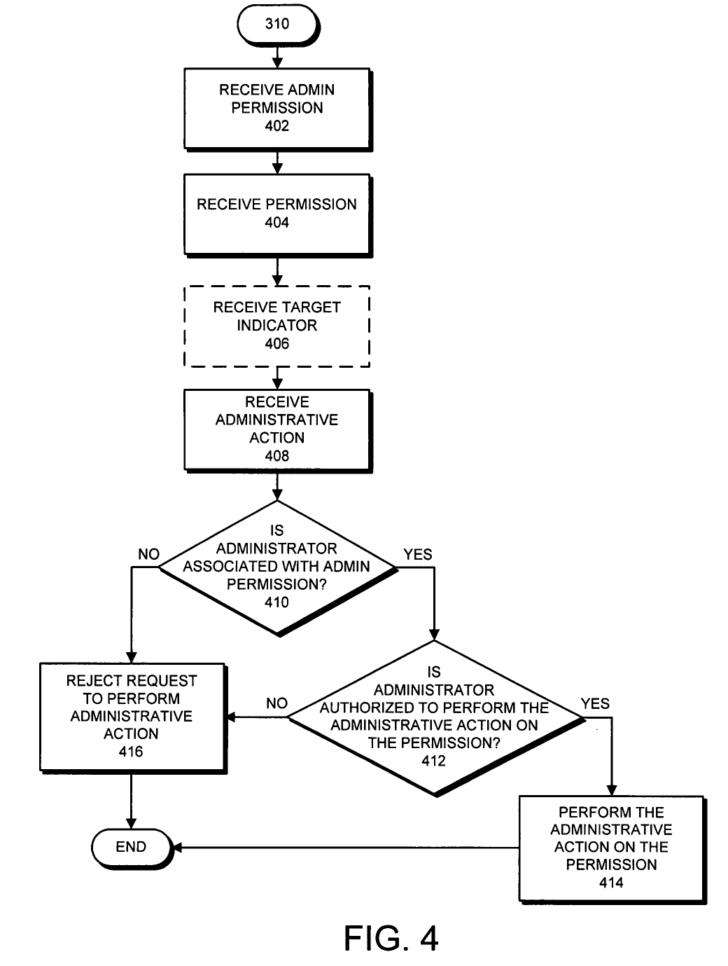

Server 150 then performs an administrative action on the permission (step 310). Note that receiving the admin permission enables server 150 to perform the administrative action. Furthermore, this is a multi-step process, which is described in more detail below with reference to FIG. 4.

In one embodiment of the present invention, administrator 132 creates the permission and the admin permission.

In one embodiment of the present invention, administrator 132 requests that server 150 perform the administrative action on the permission.

Performing an Administrative Action on a Permission

FIG. 4 presents a flowchart illustrating the process of performing an administrative action on a permission in accordance with an embodiment of the present invention. The process begins when server 150 receives an admin permission from database 140 (step 402). Note that this occurs in response to administrator 122 attempting to perform an administrative action on a permission associated with the admin permission. Server 150 also receives a permission from database 140 (step 404). Note that receiving the admin permission and the permission involves receiving instantiations of an admin permission class and a permission class.

In one embodiment of the present invention, server 150 also receives a target indicator (step 406), which refers to the resource that the permission or admin permission controls access to. This embodiment not only enables an admin permission to regulate a permission, but also enables such regulation with respect to specific resources. For example, by receiving a target indicator associated with file X, server 150 can grant administrator 122 an admin permission for a file-read permission that only enables administrator 122 to grant users file-read permission of file X. Note that this target indicator can refer to: a permission or set of permissions; an admin permission or set of admin permissions; a file or set of files; data; or any resource that administrator 132 or server 150 can administer. (This step is optional as is illustrated by the dashed lines surrounding step 406.)

In one embodiment of the present invention, server 150 can receive any additional information that enables server 150 to further regulate the admin permission that server 150 associates with administrator 122. For example, this additional information can include a list of users. For any user included in the list of users, administrator 122 can grant or revoke the permission, but for any user who is not included in the list of users, administrator 122 does not have the authority to administer the permission. Further examples of the additional information can include: time of day, days of the week, users' roles, users' security level, etc.

In one embodiment of the present invention, server 150 receives the admin permission, the permission, and the target indicator from administrator 122.

Next, server 150 receives an administrative action from administrator 122 to perform on the permission (step 408). Server 150 then determines if administrator 122 is associated with the admin permission (step 410). Note that this involves determining if administrator 122 is associated with the particular instantiation of the admin permission that server 150 received from database 150. If administrator 122 is associated with the admin permission, then server 150 determines if administrator 122 has authorization to perform the administrative action on the permission (step 412). If so, server 150 performs the administrative action on the permission (step 414). If administrator 122 is not associated with the admin permission, or if administrator 122 does not have authorization to perform the administrative action on the permission, then server 150 rejects administrator 122's request to perform the administrative action on the permission (step 416).

In one embodiment of the present invention, the request to perform an administrative action on the permission, is a request to perform an administrative action on a second admin permission.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating fine-grain permission management, the method comprising:
creating a permission associated with a resource;
creating an admin permission associated with the permission;
associating the admin permission with a user; and
performing an administrative action on the permission, wherein the administrative action is enabled by the admin permission.

2. The method of claim 1, wherein the permission can comprise a class, wherein the class can include:
a second permission associated with the resource;
multiple permissions associated with the resource;
an authentication-test for the user; and
a policy specification for the resource.

3. The method of claim 1, wherein the admin permission can comprise a class that specifies administrative actions on the permission that can be granted to the user.

4. The method of claim 3, wherein the permission can be a second admin permission.

5. The method of claim 1, wherein the administrative action can include:
a modify action;
a delete action;
a grant action; and
a revoke action.

6. The method of claim 1, wherein performing the administrative action involves:
receiving the admin permission;
receiving the permission;
determining if the user is associated with the admin permission;
if so, determining if the admin permission allows the user to perform the administrative action on the permission; and
if so, performing the administrative action on the permission.

7. The method of claim 6, wherein receiving the permission involves receiving a target indicator, which specifies the resource that the permission is associated with.

8. The method of claim 7, wherein determining if the admin permission allows the user to perform the administrative action on the permission involves determining if the user is authorized to perform the administrative action on the permission for the resource.

9. The method of claim 1, wherein associating the admin permission with the user creates an association between a second admin permission and the user.

10. The method of claim 1, wherein the admin permission's association with the permission creates an association between the admin permission and a third permission.

11. The method of claim 1, wherein associating the admin permission with the user creates an association between the permission and the user.

12. The method of claim 1, wherein the permission and the admin permission are stored on a database.

13. A computer-readable storage medium storing instructions that when executed by a computer cause the computer to perform a method for facilitating fine-grain permission management, the method comprising:
creating a permission associated with a resource;
creating an admin permission associated with the permission;
associating the admin permission with a user; and
performing an administrative action on the permission, wherein the administrative action is enabled by the admin permission.

14. The computer-readable storage medium of claim 13, wherein the permission can comprise a class, wherein the class can include:
a second permission associated with the resource;
multiple permissions associated with the resource;
an authentication-test for the user; and
a policy specification for the resource.

15. The computer-readable storage medium of claim 13, wherein the admin permission can comprise a class that specifies administrative actions on the permission that can be granted to the user.

16. The computer-readable storage medium of claim 15, wherein the permission can be a second admin permission.

17. The computer-readable storage medium of claim 13, wherein the administrative action can include:
a modify action;
a delete action;
a grant action; and
a revoke action.

18. The computer-readable storage medium of claim 13, wherein performing the administrative action involves:
receiving the admin permission;
receiving the permission;
determining if the user is associated with the admin permission;
if so, determining if the admin permission allows the user to perform the administrative action on the permission; and
if so, performing the administrative action on the permission.

19. The computer-readable storage medium of claim 18, wherein receiving the permission involves receiving a target indicator, which specifies the resource that the permission is associated with.

20. The computer-readable storage medium of claim 19, wherein determining if the admin permission allows the user to perform the administrative action on the permission involves determining if the user is authorized to perform the administrative action on the permission for the resource.

21. The computer-readable storage medium of claim 13, wherein associating the admin permission with the user creates an association between a second admin permission and the user.

22. The computer-readable storage medium of claim 13, wherein the admin permission's association with the permission creates an association between the admin permission and a third permission.

23. The computer-readable storage medium of claim 13, wherein associating the admin permission with the user creates an association between the permission and the user.

24. The computer-readable storage medium of claim 13, wherein the permission and the admin permission are stored on a database.

25. An apparatus that facilitates fine-grain permission management, comprising:
a creation mechanism configured to create a permission associated with a resource;
wherein the creation mechanism further is configured to create an admin permission associated with the permission;
an association mechanism configured to associate the admin permission with a user; and
an execution mechanism configured to perform an administrative action on the permission, wherein the administrative action is enabled by the admin permission.
